(19) United States
(12) Patent Application Publication
(10) Pub. No.: US 2025/0200273 A1
(43) Pub. Date: Jun. 19, 2025

(54) SECURE ELECTRONIC COLLABORATIVE DOCUMENT SEGMENTATION, ALLOCATION, AND EDITING

(71) Applicant: Ocean Friends Inc., Irving, TX (US)

(72) Inventors: Animesh Kumar, Irving, TX (US); Manish Shukla, North Bend, WA (US)

(73) Assignee: Ocean Friends Inc., Irving, TX (US)

(21) Appl. No.: 18/986,683

(22) Filed: Dec. 18, 2024

Related U.S. Application Data
(60) Provisional application No. 63/611,767, filed on Dec. 18, 2023.

(51) Int. Cl. G06F 40/166; G06F 21/60; G06F 40/197

(52) U.S. Cl. CPC G06F 40/166; G06F 21/602; G06F 40/197

(57) ABSTRACT

Utilizing a secure collaborative document segmentation, allocation, and editing system and method, users can securely edit individual sections of documents where different sections are allocated to different users or groups of multiple users. The electronic document is segregated into one or more sections. The one or more sections are allocated to one or more users. Each of the one or more segregated sections is shared with the one or more users by providing an access link to each of the one or more users to access their allocated one or more segregated section. Each edited section is received from the corresponding one or more users and compiled to automatically generate a final electronic document.

### CROSS-REFERENCE TO RELATED APPLICATIONS

This application claims the benefit under 35 U.S.C. § 119(e) and 37 C.F.R. § 1.78 of U.S. Provisional Application No. 63/611,767, filed Dec. 18, 2023, which is incorporated by reference in its entirety.

### TECHNICAL FIELD

The present disclosure relates to a system and method to selectively segment documents to informed users and securely and collaboratively edit the document segments seamlessly to capture information and deliver delivery of high quality results.

### BACKGROUND

With the widespread adoption and continuous development of computers and computer networks, there has been a significant surge in the demand for collaborative document editing and maintenance among multiple users. This demand arises from the necessity of seamless collaboration among team members and other users, especially in professional settings where documents often require collective inputs and modifications.

Recent years have witnessed significant advancements in applications facilitating remote collaboration among geographically dispersed individuals. These applications have enabled group cooperation through file sharing and internet-based communication platforms. However, many of these existing solutions lack synchronous functionality, often necessitating the laborious process of sending documents back and forth and manual compilation of all the received documents. Some require the installation of specialized software, alterations to network firewall configurations, continuous connectivity, or other complex setups.

Moreover, in certain applications, the utilization of a collaborative web platform for activities like form editing has been either severely limited or non-existent. For instance, when a user engages in form editing, opportunities for collaborative input are restricted, and in some cases, demand the installation of software or network firewall adjustments. This absence of collaborative features poses challenges for form providers in ensuring accurate and efficient data entry. Additionally, the growing acceptance of electronic or digital signatures adds an extra layer of complexity to the form-editing process.

However, conventional approaches to collaborative document editing, exemplified by products like Microsoft's online version of Office, Adobe Acrobat etc. have exhibited certain deficiencies. These shortcomings include their limited functionality and user-unfriendly interfaces, which hinder the efficient and smooth operation of collaborative document processing. The complexities inherent in these existing systems present considerable challenges to users engaged in collaborative editing and maintenance. Also, they allow sharing of the whole document or form which hinders the safety of the data to be shared.

Consider a scenario where a team of professionals is tasked with collaboratively creating a comprehensive report for a critical business presentation. In the absence of a specialized collaboration system, the team may resort to using conventional tools where each team member would work on their section of the report independently, save their respective files, and subsequently share them through email or instant messaging platforms. This approach, while functional to some extent, poses inherent challenges. The frequent back-and-forth exchanges of files can lead to version control issues, potential data loss, and an overall disjointed collaborative experience. Furthermore, coordinating inputs and feedback from multiple team members becomes increasingly complex as the project progresses. In this conventional scenario, the limitations of the existing tools may become evident, potentially slowing down the collaborative process and compromising the quality of the final document.

These drawbacks exemplify the deficiencies within conventional document collaboration tools, highlighting the pressing need for an integrated solution that seamlessly bridges the gap between offline and online modes of communication, providing a cohesive platform for efficient collaborative document processing.

Hence, there is a distinct need for a collaborative web form-editing application that allows for real-time collaboration. Developing a system or method capable of facilitating effective collaborative form editing, enabling remote verification of form accuracy, would be a significant advancement in this field.

In light of the challenges and unmet needs outlined above, the present disclosure aims to revolutionize the field of collaborative web document editing, providing a solution that addresses the limitations of existing approaches and offers a seamless, efficient, and user-friendly platform for synchronous collaboration in document editing activities conducted over the internet.

### SUMMARY

The present disclosure relates to a system and method to fill out an electronic document collaboratively. In particular, the disclosure relates to editing out an electronic document or form in collaboration with one or more users to simplify the task of document editing by enabling one or more users to work together seamlessly in a secured environment. The disclosure further allows delivering high-quality result and capturing the relevant information from the corresponding user.

In one aspect of the present disclosure, a method to fill out an electronic document in collaboration with one or more users is disclosed. The method includes allocating one or more sections of the electronic document to one or more users. The electronic document is then segregated into corresponding one or more sections based on the allocation. Each of the one or more segregated sections is shared with one or more users by providing an access link to each of the one or more users to access their allocated one or more segregated section. The one or more filled-out sections are received from the corresponding one or more users and compiled to automatically generate a final electronic document.

In another aspect of the present disclosure, a computer-implemented system to fill out an electronic document by collaborating with one or more users is disclosed. The system includes a computing device that further comprises a user interface to allow access to a collaborative document-editing platform. It further includes a memory to store instructions, and a processing device operatively coupled to the platform and is configured to execute instructions to allocate one or more sections of the electronic document to one or more users, where the first user provides information related to the one or more users to whom the one or more corresponding sections are to be allocated. It further segregates the electronic document into one or more sections based on the allocation. Each of the one or more segregated sections is shared with one or more users, where an access link is shared with each of the one or more users on their computing device to access their allocated one or more sections. The one or more filled-out sections is received from the corresponding one or more users and compiled automatically to generate a final electronic document, where the final electronic document includes the information received from each of the one or more users.

In an aspect, one or more multimedia elements may be inserted into one or more sections allocated to one or more invited users, where one or more multimedia elements comprise one or more images, video files, and audio files.

In yet another aspect, one or more notifications are sent to one or more invited users about the shared section of the electronic document.

Advantageously, the collaborative document-editing platform provides multilingual support, allowing one or more users to fill their allocated one or more sections in their preferred language.

### BRIEF DESCRIPTION OF THE DRAWINGS

The above-mentioned implementations are further described herein with reference to the accompanying figures. It should be noted that the description and figures relate to exemplary implementations and should not be construed as a limitation to the present disclosure. It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

FIG. 1 illustrates a computer-implemented secure collaborative document segmentation, allocation, and editing system used to fill out an electronic document in collaboration with one or more users.

FIG. 2 illustrates a method to edit out an electronic document in collaboration with one or more users.

FIG. 3 illustrates an exemplary method to fill out an electronic document i.e., a medical intake form of a child in collaboration with one or more users.

FIG. 4 illustrates an exemplary view of the front page of an electronic document i.e., the medical intake form to be filled out in collaboration with one or more invited users.

FIGS. 5a and 5b illustrate an exemplary view of one or more sections of the document i.e., the medical intake form to be filled out in collaboration with one or more invited users.

FIG. 6 illustrates a share form that allows the first user to share one or more sections to one or more invited users to fill out the electronic document i.e., the medical intake form in collaboration.

FIG. 7a illustrates an exemplary view of a section named home environment of the electronic document i.e., the medical intake form to be filled in collaboration that is shared with one or more invited users using an access link.

FIG. 7b illustrates an exemplary view of a section named behavior of the electronic document i.e., the medical intake form to be filled in collaboration that is shared with one or more invited users using an access link.

FIG. 8a illustrates an exemplary view of a section named home environment of the electronic document i.e., the medical intake form that is filled by the corresponding invited user.

FIG. 8b illustrates an exemplary view of a section named behavior of the electronic document i.e., the medical intake form that is filled by the corresponding invited user.

FIG. 9 illustrates an example implementation that discloses how a notification of the invitation to fill out the electronic document i.e., the medical intake form collaboration is communicated to one or more invited users.

FIG. 10 illustrates an example implementation that discloses how a notification of the reminder to fill out the electronic document i.e., the medical intake form in collaboration is communicated to one or more invited users.

### DETAILED DESCRIPTION

Embodiments, of the present disclosure, will now be described with reference to the accompanying drawing.

In the following description, certain specific details are set forth in order to provide a thorough understanding of various disclosed embodiments. However, one skilled in the relevant art will recognize that embodiments may be practiced without one or more of these specific details, or with other methods, components, materials, etc.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In one aspect of the present disclosure, a secure collaborative document segmentation, allocation, and editing system and method enables collaborative editing of an electronic document by multiple users. Furthermore, different segments of the electronic document often have different contributors with different knowledge. For example, when completing a medical intake document, the document may request information within the purvey of multiple individuals, such as parents, doctors, teachers, therapists, counselors, grandparents, etc. No one individual has the knowledge to provide all the requested information. Conventional document systems require one primary user to either collect all knowledge from all knowledgeable individuals or forward the document to all knowledge individuals for completion. A problem with the first conventional approach involves placing a large burden on the primary user and possible data entry inaccuracies. A problem with the second conventional approach involves sending an entire document to each knowledgeable individual with either manual instructions to complete only certain portions or leaving the knowledgeable individual to guess at responses or potentially enter inaccurate information to answers outside of the individual's knowledge domain. A second problem with the second conventional approach is that individuals will have access to information that may be confidential and should not be seen by all users.

The secure collaborative document segmentation, allocation, and editing system and method enable users to edit, such as editing out, an electronic document collaboratively through the allocation of one or more sections of the electronic document to one or more users. The system and method revolutionize the way information is collectively curated. This process involves a seamless segregation, also referred to as “division,” of a document into one or more sections, with each section allocated to corresponding individuals or teams based on their expertise or responsibilities. By doing so, the collaborative effort becomes more focused, enabling each user to contribute their specialized knowledge and insights to their designated one or more section. The process also maintains confidentiality of individual section responses. This approach not only streamlines the document editing process but also harnesses the collective expertise of a diverse group, resulting in a comprehensive, informed, and well-rounded final document. This secure collaborative document segmentation, allocation, and editing system and method of collaborative enables teams to work synergistically, making it an invaluable tool in scenarios where accuracy, efficiency, and expertise are paramount.

The secure collaborative document segmentation, allocation, and editing system and method applies to many different contexts, such as editing medical intake forms, papers, articles, contracts, surveys, and books. The following disclosure primarily discusses editing medical intake forms that are segmented by, for example, child's information, parent's information, behavior, medical history, etc. While the description presented herein makes specific references to the medical intake forms, but it is to be appreciated that the aspects of the present disclosure are also equally applicable to editing out an electronic document in collaboration in areas like business contracts, survey editing, corporate or government contracts, applications, other structured data-entry forms and so on. In other contexts, a book can be segmented by, for example, chapters, an article can be segmented based on paragraphs, a paper can be segmented based on sections, etc. Exemplary types of users are described that can participate in aspects of the secure collaborative document segmentation, allocation, and editing system and method to fill out an electronic document in collaboration. The following are examples of such users in the medical intake form context:
Unique User—a consenting individual assigned and confirmed to fill out the electronic document. A unique user, for instance, may include any individual like family, caregivers, teachers, maids, and so on.
Permissive User—a consenting individual, application, program, organization, and/or platform assigned, permitted by a user (e.g., a unique user) to share one or sections with. This may include users involved in business, stakeholders, corporate users, users involved in government services, and so on.
Clinician(s)—a consenting party, or parties, who has the medical details of the user whose forms or documents need to be filled. This may include doctors, clinicians, physicians treating the patient, obstetricians who delivered the patient, nurses who were there during delivery, therapists, if the patient is undergoing any therapy, and so on.
Third Parties—a consenting party, or parties, with whom the documents are shared. It may include users other than the same organization or company or institute with whom the document needs to be shredded to be filled up in collaboration. A third party may interact with a user in various ways, such as in-person and/or remotely via an approved application and/or platform and in a secure manner.

The system and method disclosed herein includes editing an electronic document by editing out the document in collaboration with one or more users. The disclosure includes allocating the one or more sections of the electronic document to one or more users, based on which the electronic document is segregated into corresponding one or more sections depending upon the expertise of the corresponding one or more users in the allotted one or more section. The one or more users disclosed herein comprise a first user who shares the invite and the one or more invited users who receive the invitation to fill the one or more sections of the documents in collaboration. The one or more segregated sections are shared with one or more users using an access link, which is provided to each of the one or more users to access their allocated one or more section. The one or more users fill out the one or more segregated section shared with them, and the one or more filled sections is received from the corresponding one or more user. All the one or more filled out sections gets compiled automatically to generate a final electronic document. The final electronic document includes the details filled by the corresponding one or more user. Hence, no manual intervention is required for document compilation after receiving the filled one or more sections from the one or more users.

The description disclosed herein is not only limited to parents of the patient (in case of medical intake forms) as a first user who receives the medical intake form from the hospital through a collaborative document editing platform, where the treatment of the patient i.e., the child is taking place. First users may also include family members, extended family members who have access to that platform. Further, the one or more invited user may include teachers of the patient, other therapist, doctors, coaches of the patient (if the patient is undergoing any other treatment with some other doctor, therapist), nurses who attended the mother and child during delivery, caretaker, and maid of the patient and so on. In the description the example of child as a patient is considered but it could be any other person as well. Further it should be noted that the present disclosure is written with reference to the medical intake form but, it is not limited to, as it may also include business contracts, survey editing, corporate or government contracts, applications, other structured data-entry forms and so on. Also, the term ‘user’ disclosed herein may include any person who has knowledge of that particular one or more section of the document allocated to him/her.

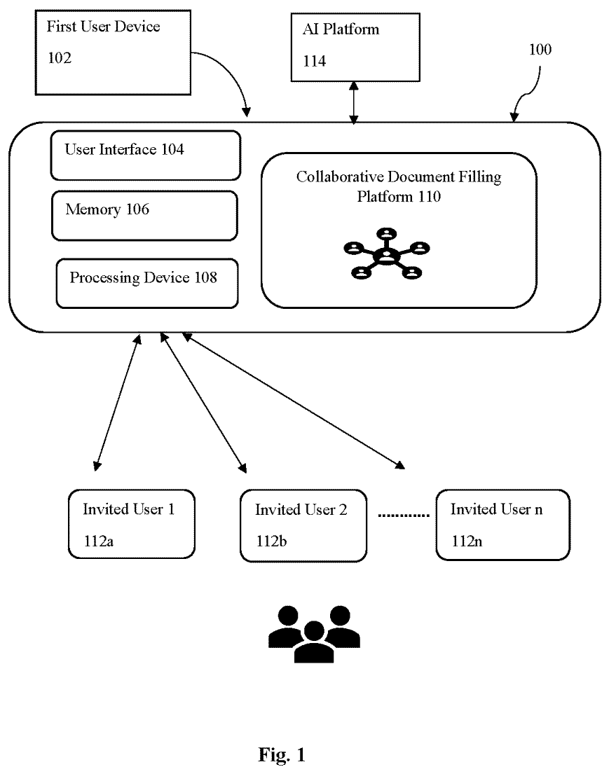

FIG. 1 depicts an exemplary computer-implemented secure collaborative document segmentation, allocation, and editing system 100 used to fill out an electronic document in collaboration with one or more users.

While the secure collaborative document segmentation, allocation, and editing system 100 discussed here refers editing out an electronic document which is a medical intake form, it should be noted that the secure collaborative document segmentation, allocation, and editing system 100 may also be used for editing various other documents, where the documents need to be filled in collaboration with more than one or more people. Some of the exemplary documents may be business contracts, survey editing, corporate or government contracts, applications, other structured data-entry forms and so on. Further, the term electronic document stands for any kind of online document or digital document that can be accessed via a computing device like mobile, computer, laptop, tablet, and so on.

The secure collaborative document segmentation, allocation, and editing system 100 includes one or more components that work in tandem to provide a seamless user experience. In the shown embodiment, the secure collaborative document segmentation, allocation, and editing system 100 includes a first user device 102 which has access to the electronic document (not shown). As shown, the first user device 102 includes a user interface 104, a memory 106, a processing device 108, and a collaborative document editing platform 110. The processing device 108 includes one or more processors executing instructions to cause the processing device 108 to perform various operations discussed below. The first user device 102 is operatively coupled to the user interface 104, memory 106, processing device 108 and the collaborative document editing platform 110. The secure collaborative document segmentation, allocation, and editing system 100 further includes one or more invited users 112a, 112b, . . . , 112n, which are remotely located and are commutatively connected to the first user device 102 via a communication network (not shown). The one or more invited user 112a, 112b, . . . , 112n interacts with the secure collaborative document segmentation, allocation, and editing system 100 using a computing device including, but not limited to, a mobile device, computer, tablet, laptop and so on. The first user device 102 shares an access link of the one or more sections of the document to the one or more invited users 112a, 112b, . . . , 112n. The memory 106 stores the instructions and it also stores the different versions of the filled documents which can be used by the first user, whenever needed.

The first user device 102 may include any computing device such as a mobile, computer, tablet, laptop, computer, and so on that can access the collaborative document editing platform 110. The first user i.e., the person who has access to the document shares one or more sections of the document with the one or more invited user 112a, 112b, . . . , 112n i.e., where the invited users are people having expertise in filing their specific section. In an exemplary scenario, the collaborative document editing platform 110 provides a medical intake form of the patient to the parent of the patient i.e., the first user who allocates and segregates the one or more section of the document and shares it with one or more invited user 112a, 112b, . . . , 112n by using an access link. Here, in this example, the first user may include either parent of the patient and one or more invited user 112a, 112b, . . . , 112n may include family, extended family of the patient, caregiver, maid of the patient, doctors, nurses, physician, clinician, therapist (if patient is undergoing any therapy) of the patient, doctors, and nurses of the mother during delivery of the child, teacher of the patient, friends of the patient and so on. The one or more invited user 112a, 112b, . . . , 112n includes mostly those users who have an expertise in the corresponding one or more section shared with them. In the given example, a medical intake form editing is disclosed but it may include other documents like business contracts, survey editing, corporate or government contracts, applications, other structured data-entry forms and so on. Based on this, the first user and one or more invited user may vary which may include business head, CEO, CFO of the company, team lead and so on and office staff, teammates, colleagues and so on as one or more invited users.

The secure collaborative document segmentation, allocation, and editing system 100 includes a memory 106 which stores all the instructions to carry out the whole process of editing out the electronic document in collaboration with one or more users. The memory 106 is configured to store instructions which includes one or more user inputs, segregated one or more sections of the document, filled sections, and a final electronic document that is compiled once inputs are received from the invited users on the shared sections. The memory 106 also stores different versions of the final electronic document in order to track and manage different iterations of the document which allows retrieval of the prior versions of the document, if necessary. In an exemplary scenario, suppose the one or more invited users 112a, 112b, . . . , 112n has filled out one or more sections and there might be chances like the one or more invited users 112a, 112b, . . . , 112n has filled some details in the one or more section shared with them with which the first user does not agree or the one or more invited users 112a, 112b, . . . , 112n has filled some details which he/she finds wrong after looking at some document or thinking about it in detail later, and so on. In these exemplary cases, the one or more invited users 112a, 112b, . . . , 112n or the first user may make changes in the final document creating a new updated version of the final document which can be used for future reference. All these versions get saved in the memory 106 operatively coupled to the first user device 102.

The first user device 102 includes a user interface 104 configured to allow access to a collaborative document editing platform 110. The collaborative document editing platform 110 can be accessed via various types of user devices, including desktop computers, laptops, tablets, or smartphones, allowing user to access and fill their allocated one or more sections from any compatible device. The collaborative document editing platform 110 further displays any real time updates of the editing of the one or more segregated sections as the one or more invited users 112a, 112b, . . . , 112n may fill out their sections at different time. It further comprises incorporation of one or more multimedia elements into the one or more sections by the one or more invited users 112a, 112b, . . . , 112n. The one or more multimedia elements comprises one or more images, video files, audio files or a combination thereof. The collaborative document editing platform 110 further includes an approval workflow, where the first user reviews and approves the filled in sections, which is then compiled to get a final electronic document. In some case, the filled in sections are automatically compiled to get the final document, which is then reviewed and approved by the first user. The first user can make any edits in the received filled in sections. It should be noted that the document may include one or more interactive sections including one or more questions embedded by the first user and/or the invited user, which allows the user to communicate with each other throughout the form editing activity.

The processing device 108 is operatively coupled to the first user device 102 and serves as a primary interface between the collaborative document editing platform 110 and the first user along with one or more invited users 112a, 112b, . . . , 112n. The user interface 104, memory 106, processing device 108 and collaborative document editing platform 110 are also operatively coupled to each other. The user interface 104 is designed to be intuitive and easy to use, enabling the first user who shares the one or more sections of the document to one or more users 112a, 112b, . . . , 112n without any difficulty. Each section can be shared with one or more of the users. However, each section does not have to be shared. The processing device 108 is configured to capture and manage the data associated with the final electronic document which may include information about the one or more users 112a, 112b, . . . , 112n who contributed, timestamps of edits, version history and so on.

The processing device 108 is operatively coupled to the collaborative document editing platform 110 and is configured to execute multiple instructions which are stored in the memory 106. The instructions include allocation of one or more sections of the electronic document to one or more users 112a, 112b, . . . , 112n. The one or more users comprises a first user who shares the invite and one or more invited users 112a, 112b, . . . , 112n who receives the invitation to fill out the one or more sections of the document. The first user provides information related to the one or more invited users 112a, 112b, . . . , 112n to whom the one or more corresponding sections are to be allocated. The allocation can be done by selecting the one or more sections based on the expertise level of the corresponding one or more user 112a, 112b, . . . , 112n. The electronic document is segregated into one or more sections based on the allocation. Each of the one or more segregated sections is shared with one or more invited user 112a, 112b, . . . , 112n by providing an access link with each of the one or more user 112a, 112b, . . . , 112n on their computing devices to access their allocated one or more section. The computing device of the one or more user 112a, 112b, . . . , 112n may include smartphone, tablet, computer, laptop and so on. The sharing of the access link with the one or more user 112a, 112b, . . . , 112n is provided along with an invitation message which may be shared either through email or through the contact details of the one or more user 112a, 112b, . . . , 112n or a combination of both. The notification of the invitation is sent to the device of the one or more user 112a, 112b, . . . , 112n. The invitation along with the access link may be shared in the form of message through SMS, WhatsApp, Telegram and so on. The shared one or more segregated section is received and filled by the one or more user 112a, 112b, . . . , 112n and the one or more filled out section is received by the first user on the first user device 102 from the corresponding one or more user 112a, 112b, . . . , 112n. The one or more filled out sections are automatically compiled to generate a final electronic document which mainly includes information received from each of the one or more user 112a, 112b, . . . , 112n. The collaborative document editing platform 110 maintains a log of user activities, including logins, document access, edits, and comments, providing an audit trail for security and compliance purposes.

The secure collaborative document segmentation, allocation, and editing system 100 disclosed herein includes a first user device 102 and a user interface 104 to allow access to a collaborative electronic document editing platform 110. The collaborative electronic document editing platform 110 is the platform which includes the electronic document and can be easily accessed by the first user. For example, suppose the electronic document is medical intake form then the collaborative document editing platform 110 includes medical intake form that is to be filled in collaboration, medical details of the patient and so on.

The collaborative document editing platform 110 is further configured to assign different permission levels to the one or more users 112a, 112b, . . . , 112n (collectively, 112), where the permission levels dictate the extent of access rights granted to each user 112 for accessing their allocated section. The owner of the document assigns different permission level for the invited users 112 at the time of allocating their sections. To accomplish this, the document owner accesses the collaborative document editing platform 110 and allocate one or more sections of the document to one or more invited users 112 and to define the extent to which invited users can make changes to the received sections. For example, only invited users having access link to a defined section will be able to access the designated section. Further, in cases where multiple owners are overseeing a document, each owner possesses the capability to set restrictions for each other. This level of control enables a nuanced and tailored approach to information sharing. For example, consider a scenario where a mother is providing details about her child, yet wishes to withhold certain information from the child's father. In this instance, the mother has the ability to withhold access to the corresponding section of the form from the father, thereby safeguarding the confidentiality of sensitive information from other persons including father of the child. In another example, a doctor may share a form to be filled by the parents as well as their child (who is the patient), where the parents may not be able to access the details filled by the child in the form. This dynamic and customizable access control mechanism empowers owners or administrators to manage information sharing in a way that aligns with the specific needs and preferences of the individuals involved.

The collaborative document editing platform 110 is further configured to maintain version history of the shared one or more sections, where the collaborative document editing platform 110 tracks changes made by the one or more users 112a, 112b, . . . , 112n in their sections in real-time.

Further, the collaborative document editing platform 110 includes a multi-level delegation, wherein the one or more users receiving the allocated one or more sections for editing further delegates the sections to a third set of users. The third set of users may be one or more users other than the invited users. These are mainly the users that are further invited by the invited users to fill certain portions of the allocated sections. In one example, if a section related to pregnancy history of a user's mother is shared with the user's father, he may further allocate the section to their obstetrician. However, it should be noted that the level of rights to edit the allocated section by the third-party user is controlled by the first user, who originally allocated the section to the invited user (may be referred to as second user). In certain cases, the first user may choose to mask the feature of further delegation while sharing the section with the second user.

In one embodiment, the collaborative document editing platform 110 includes an option to add and/or remove notes in the one or more sections to be shared with the one or more invited users. This option of adding and/or removing the notes can be made available to both the user and the invited users. For example, while the user is allocating a section to the invited user, he may wish to include a set of instructions that the invited user should refer to while editing the section. To that end, the invited user may add another note that helps the user to review the filled in section, once he receives the filled in section from the invited user.

The collaborative document editing platform 110 is integrated with one or more of cloud storage services, automatic backup services, synchronization services, and secure storage services. It also provides multilingual support, allowing one or more users 112a, 112b, . . . , 112n to fill their allocated one or more sections in their preferred language.

The collaborative document editing platform 110 is further configured to send one or more notifications to the invited users 112. The one or more notifications relate to one or more of the following—informing about shared sections. access link to access the shared section, reminder to fill the section within allotted time, delay in editing the section, and importance of details that the invited user 112 is requested to provide in the shared section. For example, a notification sent to a parent about editing a section pertaining to the medical history of his child may include content that can convince him to fill the shared section faster, as this contributes to the faster wellbeing of his child. Further, another notification may be sent to an invited user reminding him to fill the section within a stipulated timeframe to avoid any penalties associated in case he fails to do so. In some scenarios, one or more notifications may also be received by the user who is sending one or more sections to the invited/remote users. For example, the user may receive notification informing him about the progress made by the one or more invited user in editing their sections of the electronic document. In other examples, if the invited user has not even opened the shared section, the user receives a notification about any associated and anticipated delays.

In one embodiment, the collaborative document editing platform 110 allows the automatic editing of one or more sections of the document using an artificial intelligence (AI) platform 114 that utilizes one or more AI modules, such as language models including Large Language Models (LLMs), technical guidance, to streamline the process of editing out documents. OpenAI's ChatGPT represents an exemplary AI module in AI platform 114 in FIG. 1. The secure collaborative document segmentation, allocation, and editing system 100 guides the AI platform 114 using engineered prompts designed to guide the AI platform 114 to utilize identified data and produce reliable, usable result outputs. The LLM of the AI platform 114 includes advanced piece of software designed to understand and process human language in a highly sophisticated manner. It takes the notes that have been previously stored in a distributed database and distill them into a concise and informative summary. This summary serves as a condensed representation of the information, making it more manageable and accessible for the document-editing process. The distributed database disclosed herein may include any database which stores data like a maternity hospital's dataset for storing a patient's birth record, a therapy center's dataset for storing patient's data, and so on. It should be noted that the platform may provide access to a central database (not shown) that can be part of or independent of collaborative document editing platform 110. The central database can be accessed by the users who are editing out one or more sections of the form to access information. The central database can be used to automatically provide information to the AI platform 114. In at least one embodiment, the AI platform 114 is trained to adapt to the specific context and individual preferences of the user. the AI platform 114 not only processes the raw data but also incorporates contextual information and considers the unique preferences of the user interacting with it. This personalized touch ensures that the summary generated is not only accurate but also tailored to the specific needs and preferences of the user. In at least one embodiment, a prompt to guide and constrain the AI platform 114 includes placeholders designating data sources, such as the central database, to allow the AI platform 114 to obtain detailed contextual information about the child in question. This context includes, but is not limited to, critical details such as the child's medical diagnosis, age, developmental history, and any other relevant healthcare information that is already available. Once the contextual information is established, the prompt also assigns the AI platform 114 the task of formulating and presenting appropriate questions within the document. These questions are specifically designed to gather essential information as part of the intake process. The prompt also facilitates a structured and comprehensive data-gathering interaction, ensuring that all necessary aspects of the child's background, current condition, and needs are thoroughly addressed to assist in therapeutic or clinical decision-making.

The secure collaborative document segmentation, allocation, and editing system 100 leverages a set of advanced techniques known as natural language processing (NLP) to execute a crucial task i.e., semantic searching. This process ensures that even when questions are phrased differently or expressed in varying ways, the secure collaborative document segmentation, allocation, and editing system 100 can recognize their underlying similarity. In other words, if two questions are essentially asking for the same information but are worded differently, the secure collaborative document segmentation, allocation, and editing system 100 can still identify them as related. Subsequently, the system can fetch answers to similar meaning questions asked in different ways based on the semantic searching. For example, if the question in Document 1 is mentioned as ‘What medicine did mother take during pregnancy?’ and the question in Document 2 is mentioned as ‘Medicines taken by mother during pregnancy:’. The questions mentioned in both the documents are contextually same, since both of them require the details of the medicines taken by the mother during her pregnancy period. If the user say mother, has filled the section in the document 1, the secure collaborative document segmentation, allocation, and editing system 100 will automatically do the semantic matching and fill out the details in document 2. This capability is fundamental in ensuring that the electronic document is accurately filled out with the right information. By employing NLP, the secure collaborative document segmentation, allocation, and editing system 100 demonstrates a sophisticated understanding of language and context, allowing it to perform this critical task effectively.

The secure collaborative document segmentation, allocation, and editing system 100 is capable enough of learning patterns and improving system 100 performance over time. In this context, they are applied to refine and enhance the accuracy of matching similar questions and their respective answers. By leveraging machine learning, the secure collaborative document segmentation, allocation, and editing system 100 gains the ability to adapt and refine its matching capabilities based on the data it processes. This dynamic learning process significantly elevates the precision and reliability of the system's semantic matching capabilities.

The secure collaborative document segmentation, allocation, and editing system 100 automatically saves the progress in memory 106 at regular intervals or upon specific one or more invited user 112a, 112b, . . . , 112n actions by ensuring data integrity and preventing loss of work due to unforeseen circumstances.

The one or more sections shared with the one or more invited users 112a, 112b, . . . , 112n for collaborative document editing are encrypted and shared over a communication network using secured protocols in order to safeguard against unauthorized access or interception. This maintains the confidentiality of the information shared via the filled in sections of the electronic document. Further, the activity log recording of all interactions, edits, communications made between the one or more invited users 112a, 112b, . . . , 112n are maintained. This way a comprehensive record of the collaborative editing and review of the document is done. Also, maintaining the chronological record of events that have occurred helps in achieving accountability of editing the sections comprehensively and accurately. The secure collaborative document segmentation, allocation, and editing system 100 disclosed here may also track changes made in the filled sections by different user to identify who made the changes, and when the changes were made. The activity log may record all activities associated with the changes made in the document including type of changes, depth of changes, and time when the changes were made.

The system 100 is configured to share one or more sections of the document to one or more users for periodic updates. For instance, once the document is generated based on responses received from one or more user, certain sections in the document may need to be updated on regular based. In such instance, the user may set frequency of sharing these sections with the remote users on periodic basis such that based on the received responses to these sections the document can be automatically updated. In some scenarios, these sections are shared with one or more users based on manual triggers such that the updates filled by the users in one or more sections are received to generate an updated document having up-to-date information.

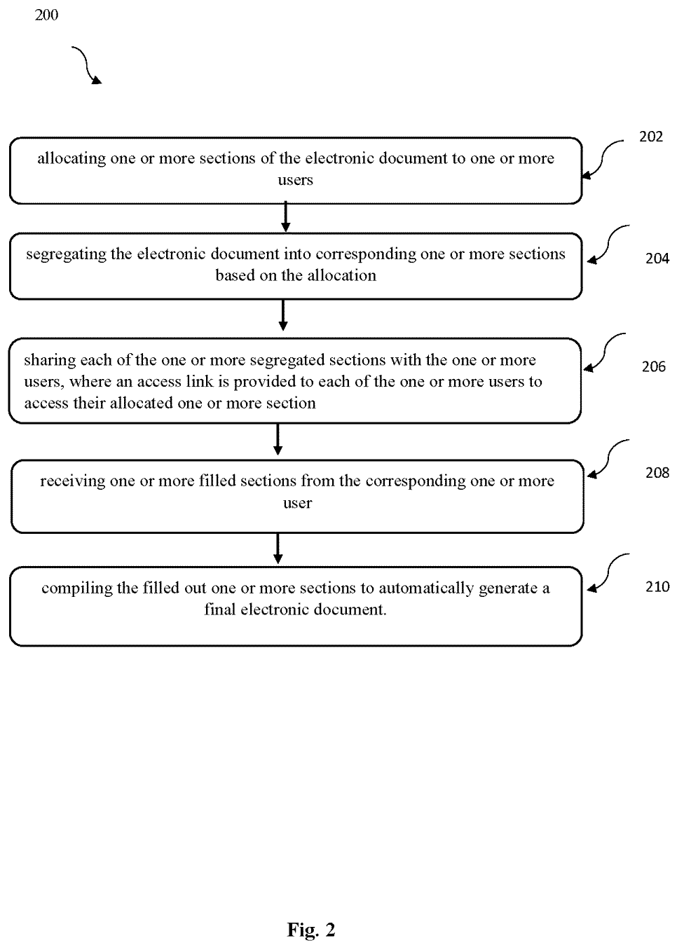

FIG. 2 illustrates an exemplary method document completion process 200 to edit an electronic document in collaboration with one or more user. In at least one embodiment, the secure collaborative document segmentation, allocation, and editing system 100 operates in accordance with a document completion process 200 to edit an electronic document in collaboration with one or more users.

Step 202 of the document completion process 200 involves allocating one or more sections of the document to one or more users. In at least one embodiment, the one or more users form a primary layer of sharing. In another embodiment, the one or more users can further share the one or more sections of the document to the other users forming a secondary layer of sharing. In this regards, the secure collaborative document segmentation, allocation, and editing system 100 allows a multiple level of sharing of the one or more sections of the document. The one or more users described herein comprise a first user who shares the invite using an access link and the one or more invited users who receive the invitation to fill out the one or more segregated sections of the document to be filled in collaboration. The details of the first user and the one or more invited users are described above in detail. In the present disclosure, the document, for example, is considered as a medical intake form for better explanation. In the given example, the document is a medical intake form, and the form includes one or more sections like ‘child's information, parent's information, behavior, gestation history, medical history, surgical history, treatment history, home environment, emotional development, insurance and so on’. These one or more sections disclosed above further include a number of sub-sections that need to be filled and require detailed knowledge about that particular field. For example, the section ‘gestation history’ further includes sub-sections like ‘medicines taken during pregnancy, food eaten during pregnancy, type of delivery, duration of labor’ and so on. These are some of the information that only the mother of the child knows or the maid or any caretaker or any other family member who was there full time with the mother during her pregnancy journey. So, in this case, such a section would be allocated to either the mother or her caretaker during pregnancy. This allocation of the section is performed by the first user. Typically, the first user identifies the appropriate person to allocate the section in order to receive the relevant answer to the corresponding section of the document. There could be plurality of ways in which allocation of one or more section may take place. For example, the first user, for instance, the father of the patient, may allocate the section to the invited user by editing in the corresponding details associated with the invited user. For example, he may enter his phone number, email id, or a combination of both. Moreover, in at least one embodiment, the first user is given with the choice to either fill the one or more sections of the documents themselves or pass the one or more sections of the documents to the one or more invited users who will receive the access link through notifications such as Short Messaging Service (SMS), email, or in app notifications. In at least one embodiment, the one or more invited user may receive the complete document to fill. Step 204 involves segregating the document into corresponding one or more sections based on the allocation. Typically, the process of segregation is carried out by professionals, such as therapy center owners and therapists themselves. These individuals possess the necessary knowledge, experience, and insight to assess and determine the one or more sections and ensure the segregation is conducted effectively. The one or more sections of the document allocated to the one or more invited users is segregated based on the allocation done. In an exemplary scenario, suppose the first user i.e., father of the patient has selected gestation history section to be allocated to mother, behavior section to be allocated to the caregiver of the patient, treatment history section to be allocated to the doctor of the patient and so on. This allows segregation of the document into one or more segregated section based on the allocations made by the first user i.e., the document will get divide into one or more sections and the first user can individually each one or more segregated section with the one or more invited users.

Step 206 involves sharing each of the one or more segregated sections with the one or more users by providing the access link to each of the one or more users to access their allocated one or more segregated sections. After the document is automatically segregated and converted into one or more segregated sections based on the allocation done by the first user on the basis of the expertise of the one or more invited users, the one or more segregated sections is shared with one or more invited users by providing them as the access link. When the first user specifies the one or more invited users who needs to fill out the one or more segregated sections, the access link is generated. The access link is a smart dynamic deep link. When the one or more invited users clicks on the provided access link the one or more invited users will be asked for a passcode to make sure they are authentic invited user for the access link. If they click on the access link on the user device, such as: mobile phone, tablet and the like, they will be directed to the application store to download the application. Once the one or more invited users download the application, they can open the application and fill out the one or more segregated sections. If the one or more invited users is using the user device such as desktop, laptop and the like, they don't need to download the application, then they can fill out the one or more segregated sections on the browser after authentication. Moreover, the access link is shared with the one or more invites users either directly through email or using the contact details like phone number of the one or more invited users. The access link can also be shared using a combination of both the email and the contact details. Using the contact details i.e., phone number of the one or more invited users, the shares link of the one or more segregated section to be filled out in collaboration is shared with one or more invited users via., SMS, message, WhatsApp message, Telegram message or through any other similar service. It can be shared to one or more invited user device which may include mobile, laptop, tablet, computer and so on. Using the access link, the one or more invited user may access the one or more segregated sections allocated to them based on their expertise in that corresponding field. Further, the one or more segregated sections shared with the one or more invited users for collaborative document editing is encrypted and shared over a communication network using secured protocols in order to safeguard against unauthorized access or interception. The communication network here may include LAN, WAN, WLAN, Ethernet, cellular network, or any other similar network which allows sharing of the documents.

Step 208 involves receiving one or more filled out sections from the corresponding one or more users. The one or more invited user after receiving the shared link, uses that link to access the one or more segregated sections of the document allocated to them and to fill out the details wherever required. The real time updates of the editing of the one or more segregated sections are visible to the first user as the one or more invited users may fill out one or more segregated sections at different time. For example, the first user, i.e., the father, shares the ‘gestation history section’ to the mother of the patient. The mother while editing out the details of the corresponding section undergoes some confusion or might get some urgent work like work related to the child or something else and so on. Then, in that case, she will fill out the corresponding section later on whenever she will have time. Suppose initially she has filled 2 sub-sections which marks up to 40% of the details, then the platform will show a progress status of the corresponding section as 40% completed.

Step 210 involves compiling the edited one or more sections to automatically generate a final electronic document. The received one or more filled out sections are automatically compiled together to generate a final electronic document. It does not require any manual intervention to compile all the filled out one or more segregated sections, which saves a lot of time and human efforts. It also reduces the chances of error that may occur due to manual compilation of filled out one or more sections, since there can be misplacing of the data filled out by the one or more invited users. Typically, the compiling is done when the one or more invited users provides the filled out one or more segregated sections, the answer to each segregated section is stored in the central database. The central database allows first user or any person who has access to open the final electronic document and check the progress of the one or more invited users corresponding to the one or more segregated sections.

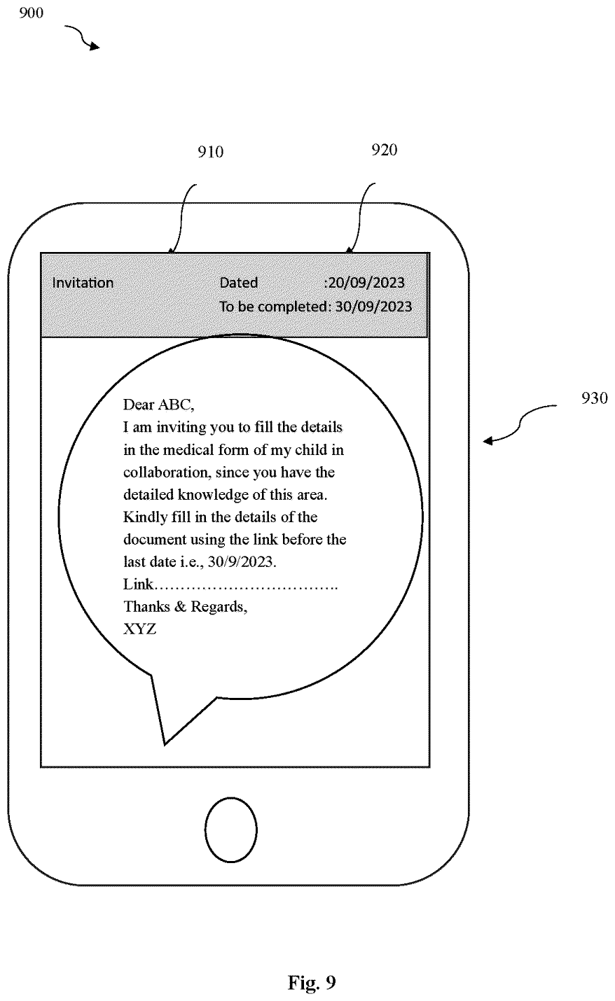

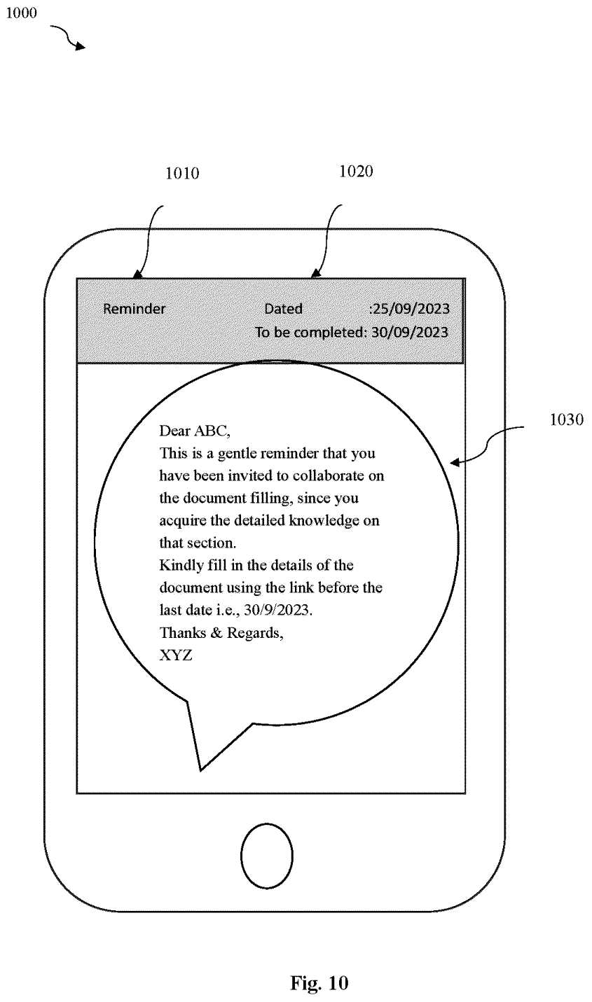

The method 200 disclosed herein further comprises sending one or more notifications to one or more users about the shared section of the electronic document. The one or more notifications relate to one or more of the following—access link shared to access the section, reminder to fill the section within a given time, delay in editing the section, and importance of details that the one or more user is requested to provide in the shared section. The one or more notification is also sent to the one or more invited user on their device similar to the invitation of document editing. The one or more notification may be shared to the one or more invited users via email or messaging using their contact details or a combination of both. The messaging may involve use of applications like SMS, WhatsApp, Telegram and so on. The device of the one or more invited user may include tablet, mobile, computer, laptop and so on. This is explained below in detail in FIGS. 9 and 10.

The method 200 disclosed herein further comprises incorporation of one or more multimedia elements into the one or more segregated sections by the invited users. The one or more multimedia elements may comprise one or more images, video files, audio files or a combination thereof. For instance, in the ‘insurance section’, the one or more invited user may incorporate the image of insurance card or any other relevant insurance details required in the medical intake form by attaching them at the corresponding sub-section.

The method 200 disclosed herein further comprises version history controlling for tracking and monitoring various iterations of the document, facilitating the retrieval of earlier document versions, when required. The collaborative document editing platform is maintaining a version history for each of the shared one or more sections by tracking the changes made by the one or more user in their corresponding allocated sections in real-time. It compares different versions of the document and highlights the changes or edits made by the one or more user and thereby facilitating a comprehensive review process. In an exemplary scenario, suppose a user is entering the details of the section ‘Medical History’ and due to some unforeseen circumstances, he/she forgets to mention any specific details like ‘Allergies’ that the child has with some medicines and some food. Then in that case, the user can again go to the share link and edit the corresponding section shared with him/her and fill in the rest of the details. This will create a new updated version of the final document. The first user can access both the documents as they gets saved in the memory.

The method 200 disclosed herein further allows use of Natural Language Processing (NLP) for semantic searching. When a user interacts with a collaborative document editing platform by asking a question or providing information and so on, the platform processes the input using NLP. This allows the platform to dissect and comprehend the nuances of the input/query. It ensures that even if similar questions are posed in different ways, the platform/system can recognize their underlying similarity. By analyzing the structure, syntax, and semantics of the questions, the system identifies commonalities in meaning. This step guarantees that the right information is associated with the right questions, regardless of how they are phrased. The NLP provides a component that allows the secure collaborative document segmentation, allocation, and editing system 100 to understand and match questions effectively. This is done by consideration of at least two elements: contextual information and user-specific preferences. Contextual information refers to the surrounding circumstances or background against which a question is posed. It could include factors like the current situation, the subject matter at hand, or any additional relevant details. By taking this contextual information into account, the system refines its understanding of the questions and their intended meaning. Additionally, the system acknowledges and adapts to individual user preferences. Different users may have distinct ways of asking or framing questions, and the system is designed to accommodate and adapt to these idiosyncrasies. For example, the questions may be ‘Please give a detailed account of baby during birth’ or ‘What is the situation of the child when he/she was born?’. These questions have same context but the way of asking is different. This personalized approach further augments the accuracy of matching similar questions and ensures that the right answers are associated with the right questions, tailored to each user's specific style of inquiry. Typically, the NLP is equipped with preliminary knowledge about the child even before the intake process of the document begins. This pre-existing information includes key details such as the child's date of birth (DOB), medical diagnosis, and other pertinent aspects of their prior medical history. These foundational data points allow the secure collaborative document segmentation, allocation, and editing system 100 to contextualize the process, enabling it to ask more targeted and relevant questions. By having access to this information in advance, the NLP can streamline the process, reduce redundancy, and ensure personalized and efficient approach to gathering additional insights via one or more sections.

The method 200 utilizes the AI platform 114 to fill out the form automatically using the previously stored forms stored in a distributed database. This the AI platform 114 includes at least one highly advanced language processing AI module capable of understanding and generating human-like text. It takes the notes that have been previously collected and stored in a distributed database and transforms them into a condensed summary. This summary serves as a distilled representation of the information, making it more manageable and accessible for the form-editing process. For example, if some subjective questions are asked to be filled in the form, say, a section is shared to speech therapist of the child which has a question disclosing ‘Please share the last 6 months updates of the child.’. In this case, the speech therapist can access the collaborative form editing platform and may generate a brief summary of the progress report of the patient during the last 6 months and extract the data from that report and place it in the corresponding section allocated to them.

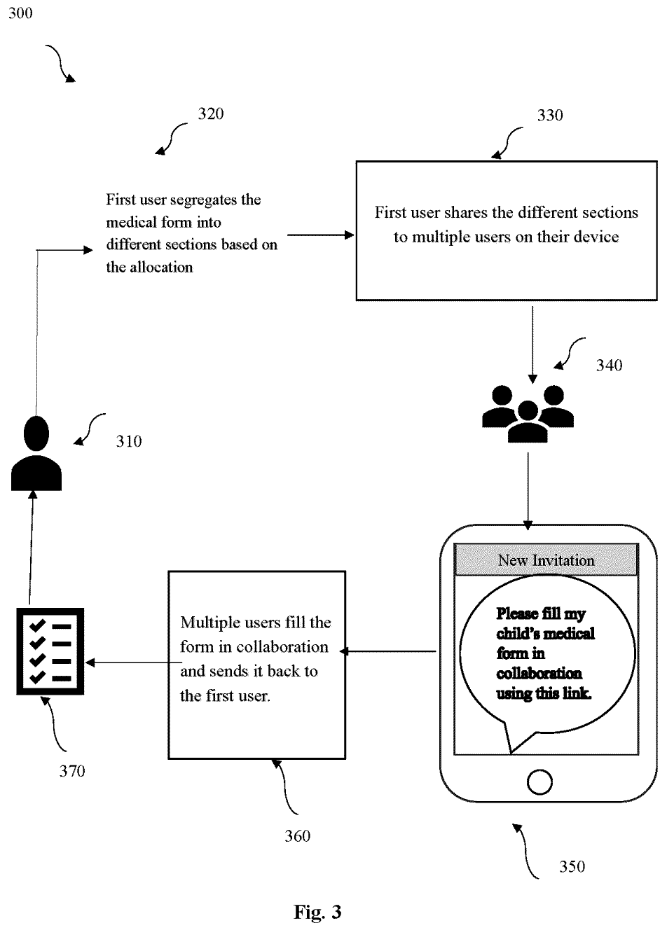

FIG. 3 illustrates an exemplary method to fill out an electronic document i.e., a medical intake form of a child in collaboration with one or more user.

The exemplary form editing method 300 allows editing out an electronic document in collaboration with one or more users includes editing of a medical intake form. But form editing method 300 is not limited only to medical intake form, it may also include business contracts, survey editing, corporate or government contracts, applications, other structured data-entry forms and so on. Further, based on the type of the electronic document the one or more users also varies. For example, in case of medical intake form, the one or more user i.e., the first user and one or more invited user may include parents of the patient, family, extended family of the patient, teachers, friends, doctors, therapist of the patient, nurses and doctors of the mother during delivery and so on. Similarly, in other cases the one or more user i.e., the first user and one or more invited user may include CEO, CFO of the company or organization, team leaders, employees, stakeholders, and so on.

Considering the first user 310 i.e., the user who is father of the child in the present example. The first user 310 can access the collaborative document editing platform where the medical intake form (in case of present example) is made available to him. This is the electronic document that needs to be filled in collaboration with one or more invited users. The first user 310 allocates the one or more sections electronic document i.e., the medical intake form of his child to one or more users and segregates it based on the allocation 320. This is done by selecting the corresponding one or more sections of the medical intake form and allocating a section to one or more users by segregating the electronic document into one or more segregated sections and allocating the section each section based on the expertise of the one or more users in the corresponding field. For example, the ‘behavior section’ details may be allocated to a caregiver of the patient, ‘gestation history section’ may be allocated to the mother of the patient, and so on. In this way based on the allocation, the electronic document i.e., the medical intake form is segregated into one or more section like ‘child's information, parent's information, behavior, gestation history, medical history, surgical history, treatment history, home environment, emotional development, insurance and so on’.

The first user 310 shares the segregated one or more section to one or more invited user 330 by providing an access link of the one or more segregated section to the one or more invited users 340 who have expertise in the corresponding section allocated to them. The access link may be shared using an email or any other messaging apps or a combination of both. Further, the access link may be shared to one or more invited user device which may include mobile, tablet, laptop, computer and so on. Here, in this example, the access link of the one or more segregated section 330 is shared to one or more invited users 340 on his/her mobile device in the form of an invitation 350 which may be either through email or message or a combination of both. The message may include ‘Please fill my child's medical form in collaboration using this link’.

The one or more users 340 after receiving the one or more segregated sections fill out the corresponding one or more section allocated to them and upon editing up of the one or more segregated section, the filled out one or more sections are automatically sent in 360 to the first user 310. The filled out one or more section gets automatically compiled without nay manual intervention and results in a final electronic document 370 i.e., the completely filled medical intake form of the patient.

For example, suppose the first user 310 i.e., the father of the child allocates the one or more sections to one or more users 340 and segregates the medical intake form into one or more sections based on the allocation 320. The one or more segregated sections are shared in 330 with one or more users 340 which may include mother of the patient, doctor of the patient, caregiver of the patient and so on. The mother fills out the ‘gestion history section’ shared with her, doctor fills out the ‘treatment history section’ shared with him, caregiver fills out the ‘behavior section’ shared with her and so on. In this way, the whole medical intake form gets filled out and is received by the first user 310 i.e., the father of the child in a compiled manner 370. The final form includes all the filled-out sections compiled together automatically.

In this manner, the user who has the knowledge of the specific field is allocated the corresponding section to be filled which leads to intake of correct and reliable information and it further reduces the time of editing of a document. Since if it is to be filled out by a single person, then he/she may not have knowledge of all the fields to be filled and it may be time consuming as well.

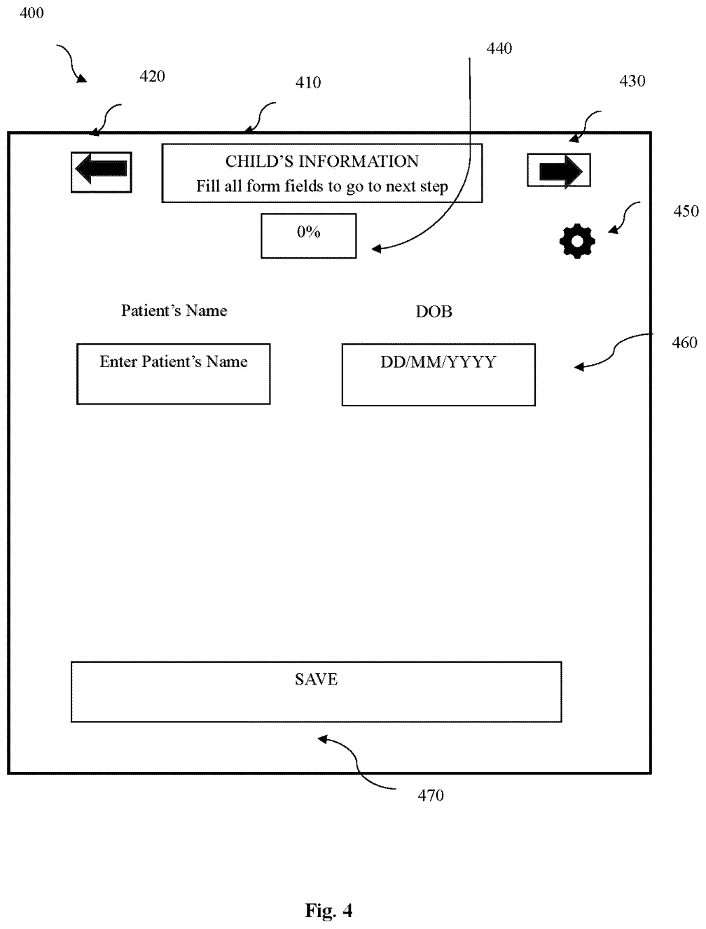

FIG. 4 illustrates an exemplary view of the front page of an electronic document i.e., the medical intake form to be filled out in collaboration with one or more invited users.

The electronic document 400 i.e., the medical intake form of the child is shown here which is available on a platform which can be accessed by the first user. Based on the present example, the first user here may include parents of the child. It includes a tab ‘Child's Information’ 410 which shows the heading of the medical intake form 400 and mentions a sub-heading disclosing ‘Fill all form fields to go to next step’. It just discloses that the medical intake form 400 to be filled in collaboration is for the child and requires details of the child to be filled out in collaboration, since it is a lengthy form and requires multiple kind of sections to be filled. The tab 420 and 430 shows the arrow to go to the previous and the next screen respectively.

The tab 440 shows the current status of the given page of the medical intake form 400 in terms of percentage i.e., how much form is filled is shown here in percentage. On clicking the tab 450 the first user may access the next page of the form 400 which includes the details of all the sections present in the medical intake form 400. Further, the tab 460 includes the details of the child like the ‘Patient's Name’ and ‘DOB’. The first user may enter the name and date of birth of the patient and can access the detailed medical intake form 400. Finally, the first user can save the details filled by using the tab 470 ‘Save’.

The simplicity and user-friendly approach of editing out an electronic document in a collaborative manner by one or more users saves time of the user and allows them to easily access the document once it is filled.

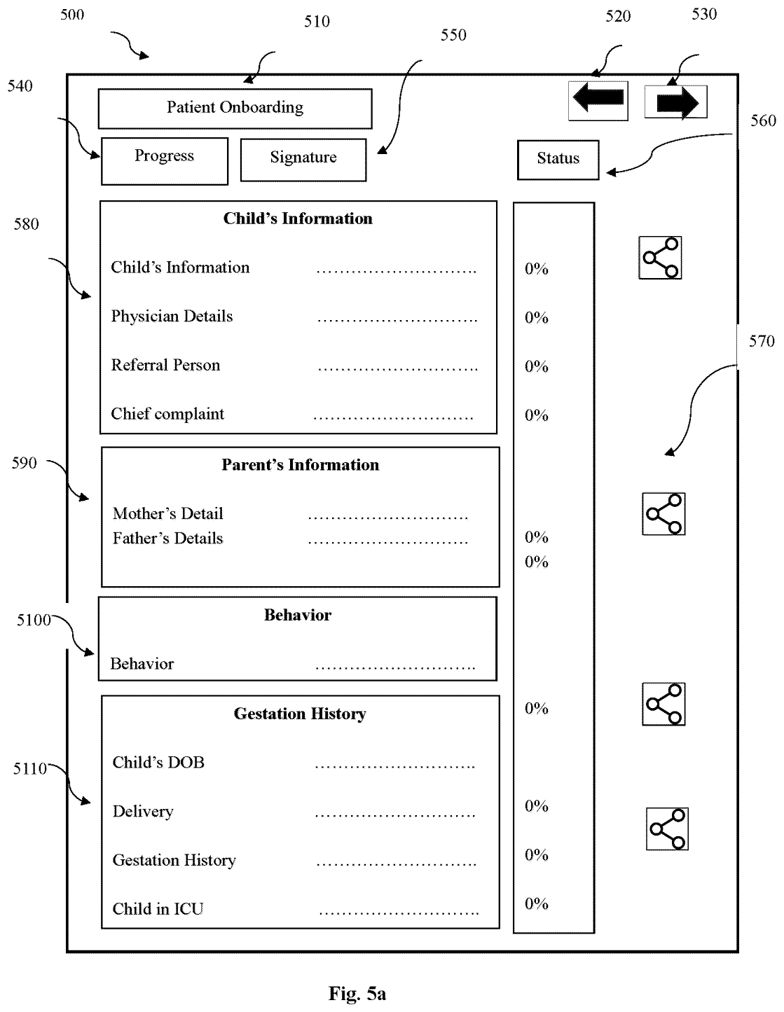

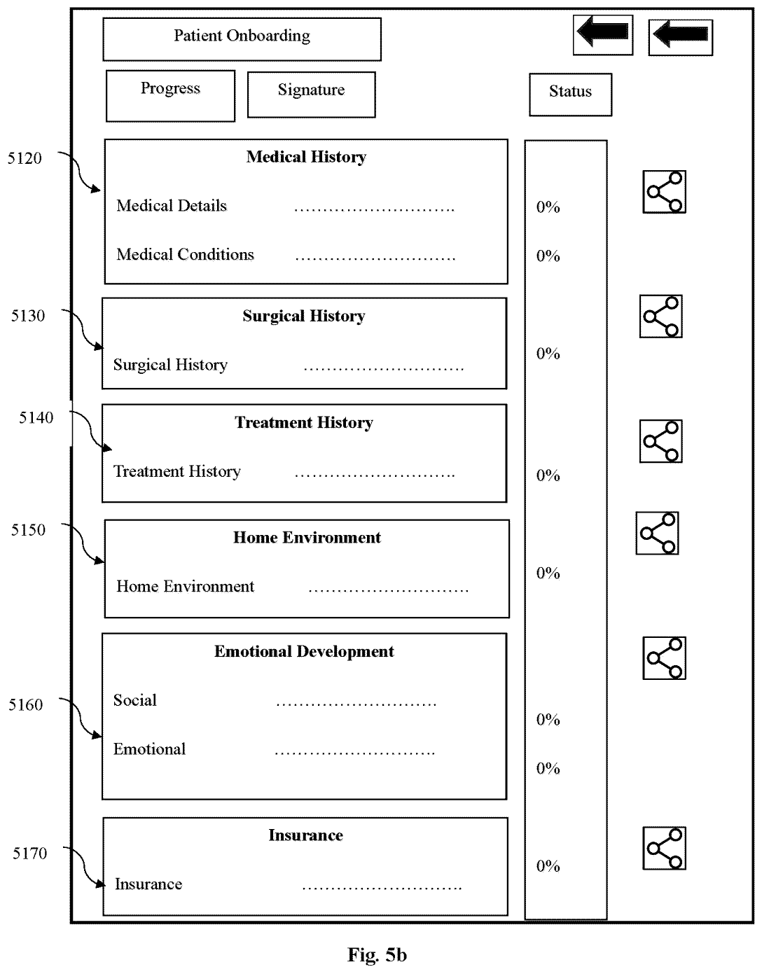

FIGS. 5a and 5b illustrate an exemplary view of the one or more sections of the document i.e., the medical intake form to be filled out in collaboration with one or more invited users.

The first user after editing out the basic details of the child when clicks on the tab which allows him/her to access the next page 500 which includes the details of all the sections included in the medical intake form of the child. It includes a tab 510 which discloses the heading of the page i.e., ‘Patient Onboarding’. It discloses that the current page 500 includes details of the patient who is getting admitted or treated. The tab 520 and 530 depicts the tab clicking on which the first user can go to the previous and next page of the medical intake form respectively. The tab 540 depicts ‘Progress’, clicking on which shows the detailed sections of the medical intake form 500. The tab 550 depicts ‘Signature’, clicking on which the first user gets the final medical intake form 500 which is filled up by the one or more user. The tab 560 depicts ‘Status’ which shows the percentage editing status of the one or more sections. The tab 570 shows the share button placed in front of each section. The first user can click on the share button 570 when he/she wishes to share the allocated one or more segregated section to the corresponding one or more user.

Further, the different sections like ‘Child's Information’ 580, ‘Parent's Information’ 590, ‘Behavior’ 5100, ‘Gestation History’ 5110, ‘Medical History’ 5120, ‘Surgical History’ 5130, ‘Treatment History’ 5140, ‘Home environment’ 5150, ‘Emotional Development’ 5160, ‘Insurance’ 5170 and so on are displayed on the current page 500 of the medical intake form.

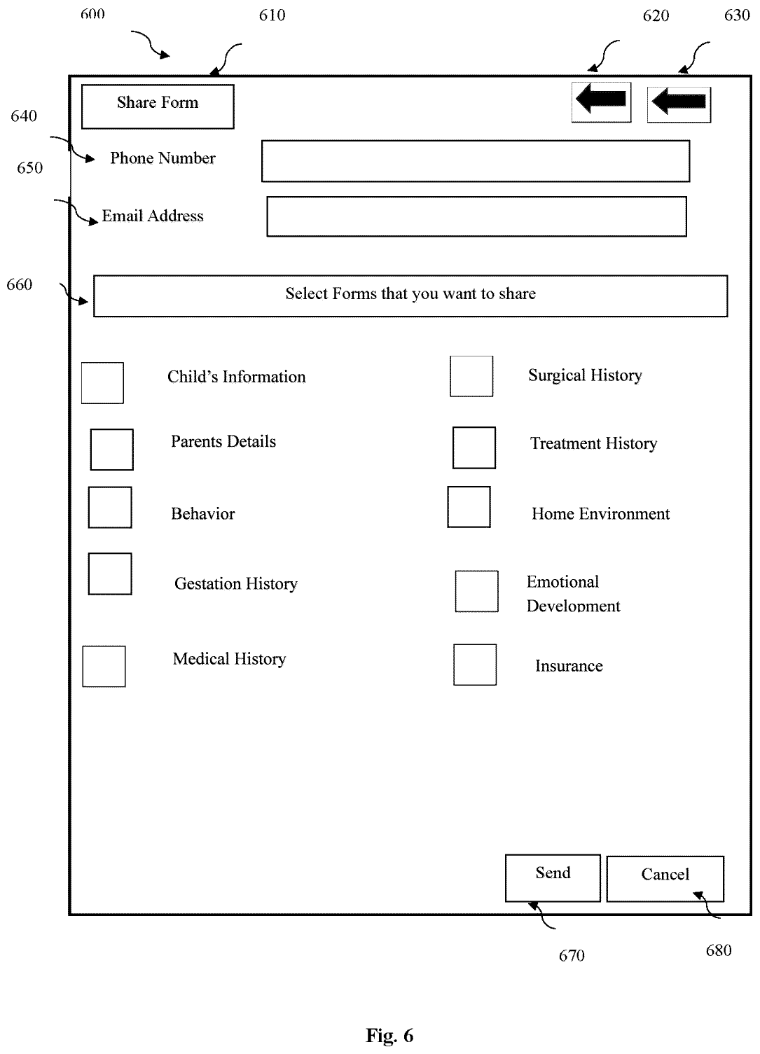

FIG. 6 illustrates a share form that allows first user to share the one or more sections to one or more invited users to fill out the electronic document i.e., the medical intake form in collaboration.

After allocating and segregating the one or more sections of the electronic document i.e., medical intake form of the child in the given example to one or more invited user, the first user shares the segregated one or more section to the corresponding one or more invited user based on his/her expertise in that particular section as explained above in detail along with some examples.

The sharing of one or more segregated section is made easy using a share form 600 which becomes available to the first user when the first user clicks on the share button present in front of each section of the electronic document. The share form 600 includes a tab 610 ‘Share Form’ disclosing the heading of the current page. It further includes tab 620 and 630 which depicts the buttons which allows the user to go to the previous and the next page on the medical intake form respectively. The tab 640 includes ‘Phone Number’ and tab 650 includes ‘Email Id’ of the one or more invited users using which the one or more segregated sections can be shared with them. The present disclosure has the advantage that it allows the first user to directly enter either the phone number of the invited user or email address of the invited user or a combination of both to share an access link along with the invitation message to fill out the medical intake form in collaboration. The access link will be sent to the device of the one or more invited uses which may include mobile, tablet, computer, laptop and so on. Further, the invitation along with the access link may be shared with the one or more invited user in the form of email or messages which may include SMS, WhatsApp message, Telegram message and so on.

Further the tab 660 ‘Select forms that you want to share’ allows the first user to select the corresponding section of the medical intake form that he/she wants to share with the corresponding one or more user who has expertise in that particular section. This would be clearer from the given example. Suppose the first user i.e., the father of the child wishes to share the ‘Gestation History’ section with the mother of the child, ‘Behavior’ section with the caregiver of the child and so on. Then the father would simply select the ‘Gestation History’ section and write down the details of the mother i.e., phone number or email id or both to share the corresponding section so that she can fill out the details therein. Similarly, the father will then select the ‘Behavior’ section and write down the details of the caregiver of the child as she takes care of the child whole day and knows the details about the behavior of the child, i.e., phone number or email id or both to share the corresponding section so that she can fill out the details therein.

The forms are carefully preprocessed and systematically divided into the one or more sections by a team of human experts. These experts typically include therapy center owners, therapists, and other professionals. The human expert analyzes the content of the forms, identifying key areas of focus, and organizing the information into logical, well-structured sections. This breakdown ensures that each section of the one or more sections addresses a specific aspect of the intake process, such as personal information, medical history, developmental milestones, behavioral concerns, and therapeutic goals. Moreover, the one or more segregated sections of the forms create an efficient, streamlined process for both data collection and analysis. As the one or more users progressively fill out the form, the entered data is securely stored in the central database in real time. The central database ensures that the information is organized, easily accessible, and efficiently managed. The one or more user with the appropriate permissions and relevant access rights, such as therapists, therapy center administrators, or other authorized personnel, can view the form data as it is being filled out. This real-time visibility allows the first user to monitor the progress of data entry, identify any incomplete sections, and ensure accuracy in the information being submitted.

The forms are pre-processed through a systematic approach to enable the secure collaborative document segmentation, allocation, and editing system 100 to facilitate the one or more segregated sections of the forms, create appropriate links for the one or more segregated sections, and send the one or more segregated sections to the one or more users. Each form is analyzed and tagged with relevant metadata to ensure that its sections having questions, and purpose are clearly identifiable. The tags may include identifiers such as form type (such as, medical history, intake form), section categories (such as, personal information, diagnosis, treatment goals), and specific user attributes (such as, age group, diagnosis type). The one or more segregated sections ensures that individual section of the form can be linked to specific user. Based on the tagging and segmentation, the secure collaborative document segmentation, allocation, and editing system 100 generates dynamic links for one or more segregated sections within forms. The links allow the first user to send the section of the form to the one or more users, such as therapists, administrators, or caregivers.

This is just an exemplary scenario. The section could be sent to other users as well who have the knowledge in the corresponding field. It further includes tabs like ‘Share’ 670 clicking on which the first user may share the one or more segregated section with the one or more invited users. The other tab ‘Cancel’ 680 may be used to cancel out the process if the first user wishes to make changes in the sharing or wishes to change the one or more invited user and so on.

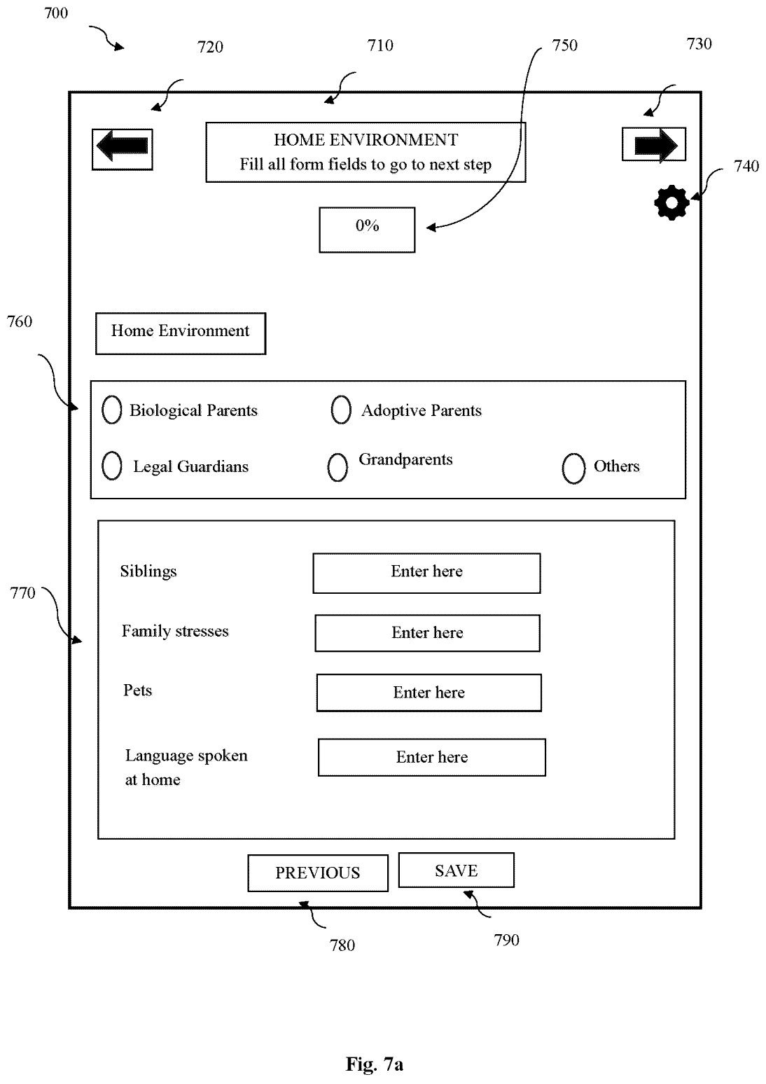

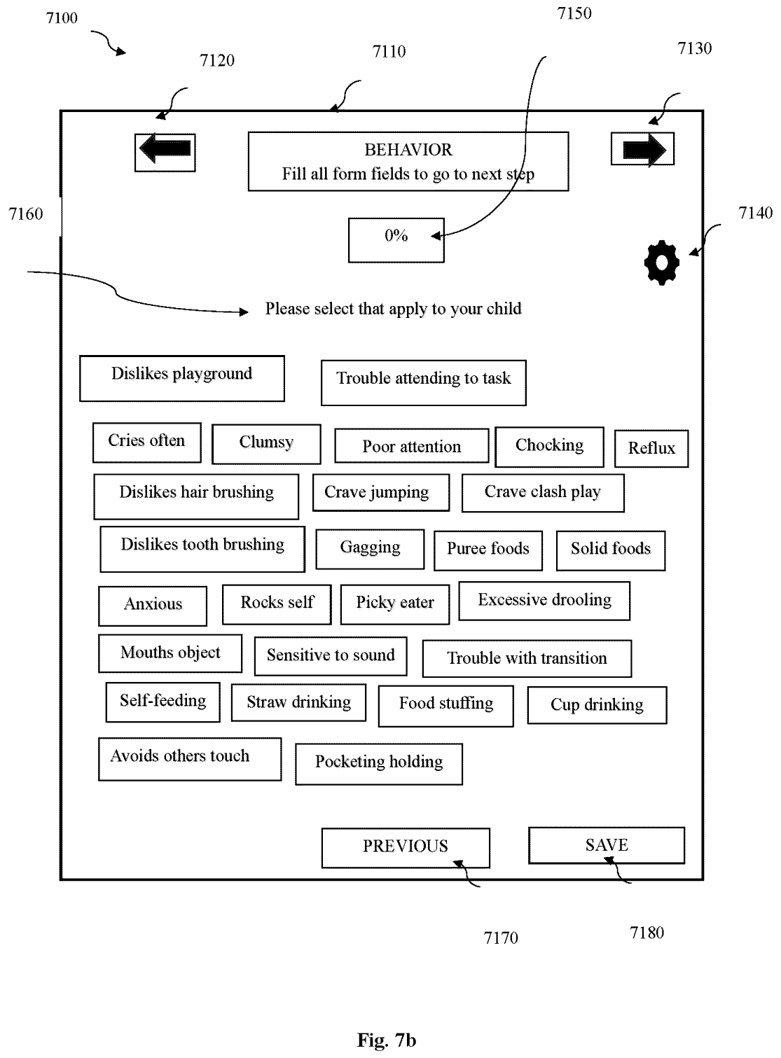

FIG. 7a illustrates an exemplary view of a section named home environment of the electronic document i.e., the medical intake form to be filled in collaboration that is shared with one or more invited user using an access link.

The exemplary view of one of the sections i.e., ‘Home Environment’ 700 of the medical intake form is shown in the present figure. It includes a tab 710 ‘Home environment’ which depicts the heading of the current section 700 of the medical intake form shared with the corresponding user. For example, this section 700 includes the details of the family background so it can be shared with the mother of the child. The section 700 further includes tab 720 and 730 which allows user to access the previous and the next page of the medical intake form respectively. It also includes a button 740 which allows user to directly access the front page of the share form as discussed in detail in the FIG. 6.

The section 700 further includes a tab 750 which shows the ‘Status’ of the section filled in terms of percentage. For example, if the mother in this case has filled few sub-sections, then it will show the progress of filled form, accordingly, say 40% and accordingly once the section is fully filled it will show 100%.

The section ‘Home Environment’ 700 is further divided into two sub-sections namely ‘Home Environment’ 760 and ‘Family Details’ 770. The sub-section ‘Home Environment’ 760 involves the details of the family structure in which the child is living i.e., whether the child is living with his/her ‘biological parents, adoptive parents, legal guardians, guardians, and others’. The first user can select the corresponding option which is correct as per their living. The second sub-section ‘Family Details’ 770 involves details of the family like ‘number of siblings, pet's details, any family stress, languages spoken at home’ and so on. These are some of the exemplary situations, the details of the sub-sections may vary depending upon the section.

The first user say father of the child shares this section 700 with the mother of the child and she will fill out the details of the corresponding sub-section 760 and 770 after receiving the corresponding section.

The section 700 further includes tabs 780 ‘Previous’ which allows user to access the previous page of the document which may include either next section or other pages of the same section which has multiple sub-sections and 790 ‘Save’ using the user can save the details entered in the document.

FIG. 7b illustrates an exemplary view of a section named behavior of the electronic document i.e., the medical intake form to be filled in collaboration that is shared with one or more invited user using an access link.

The exemplary view of one of the sections i.e., ‘Behavior’ 7100 of the medical intake form is shown in the present figure. It includes a tab 7110 ‘Behavior’ which depicts the heading of the current section of the medical intake form shared with the corresponding user. For example, this section 7100 includes the details of the behavior of the child so it can be shared with the caregiver of the child (just an exemplary scenario) who takes care of the child whole day. The section 7100 further includes tab 7120 and 7130 which allows user to access the previous and the next page of the medical intake form respectively. It also includes a button 7140 which allows user to directly access the front page of the share form as discussed in detail in the FIG. 6.

The section 7100 further includes a tab 7150 which shows the ‘Status’ of the section filled in terms of percentage. For example, if the caregiver in this case has filled few sub-sections, then it will show the progress of filled form, accordingly, say 40% and accordingly once the section is fully filled it will show 100%.

The section ‘Behavior’ 7100 is further divided into a sub-section named ‘Behavior Category’ 7160 of the child which discloses multiple options for the user out of which the user can select the respective option which stands true with respect to the behavior of the child. This may include options like ‘cries often, clumsy, poor attention, anxious, self-feeding’ and so on. These are some of the exemplary situations, the details of the sub-sections may vary depending upon the section.

The first user say father of the child shares this section 7100 with the caregiver of the child and she will fill out the details of the corresponding sub-section 7160 after receiving the corresponding section.

The section 7100 further includes tabs 7170 ‘Previous’ which allows user to access the previous page of the document which may include either next section or other pages of the same section which has multiple sub-sections and 7180 ‘Save’ using the user can save the details entered in the document.

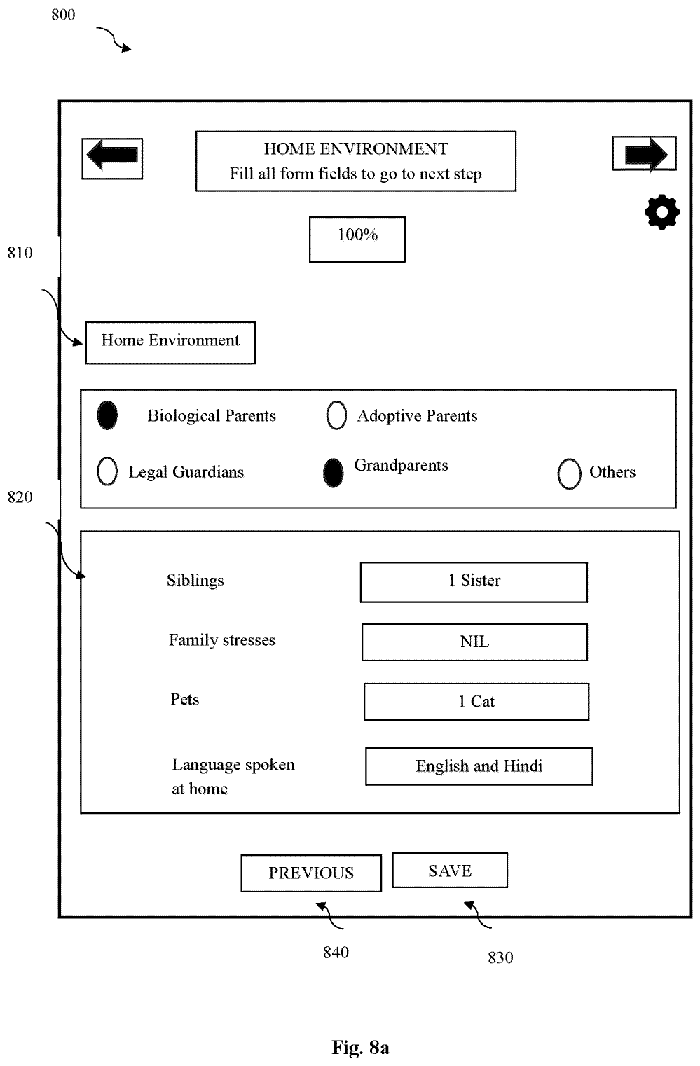

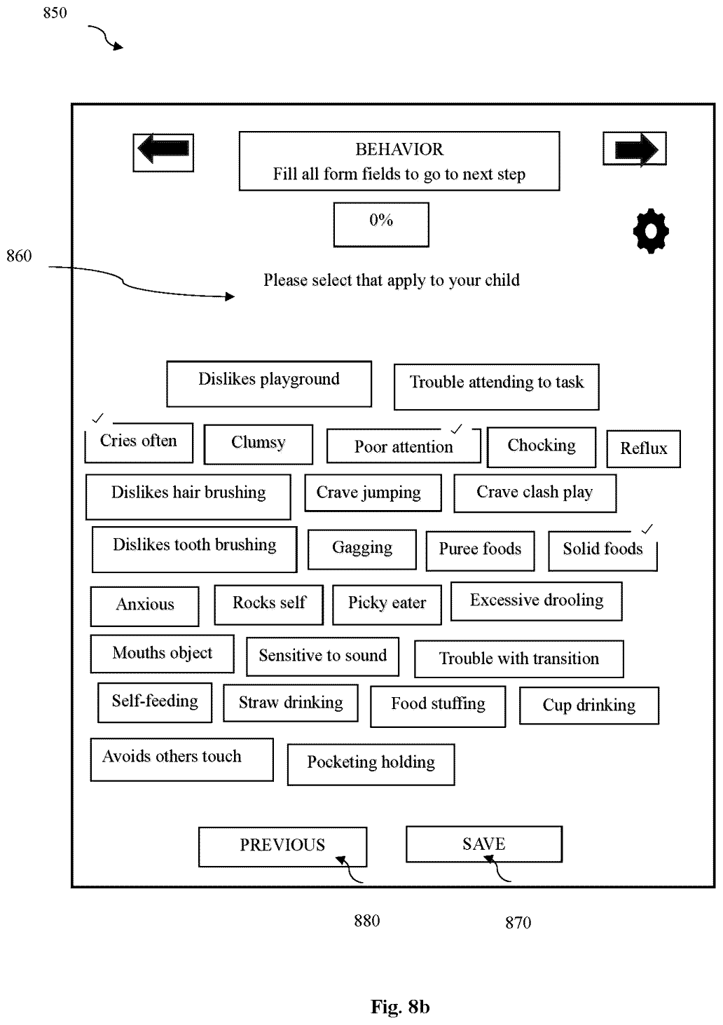

FIG. 8a illustrates an exemplary view of a section named home environment of the electronic document i.e., the medical intake form that is filled by the corresponding invited user.

The one or more invited user after receiving the one or more segregated sections fills out the details therein and the filled one or more section gets compiled to automatically generate a final electronic document i.e., a medical intake form of the child in this example. In this example, the mother of the child receives and fills up the section 800 named ‘Home environment’.

The FIG. 8a shown here is just the filled-up version of the FIG. 7a. The mother fills up the details in the sub-section 810 ‘Home Environment’ by selecting the relevant options like ‘Biological Parents and Grandparents’ as the child is currently living with his biological parents and grandparents. Further, the mother fill-up the details of other sub-section 820 ‘Family Details’ by entering the relevant information in the text boxes placed next to each question. For example, in case of ‘siblings’, the mother mentions ‘1 sister’. Similarly in case of ‘pets’, the mother enters ‘1 cat’ as they have a cat in their home and so on. Similarly, all other questions present in the section shared with user are answered by them based on their knowledge.

The section after getting fully filled up by the corresponding user shows it progress status as 100% and all the sections gets compiled automatically to generate a final electronic document.

The one more invited user after editing the document may click on the tab 830 to ‘Save’ the details entered by them. Further, the tab 840 ‘Previous’ may be used by the one or more invited user if in case more than one sections are allocated to them or the allocated section involves multiple sub-sections which are covered in multiple pages.

FIG. 8b illustrates an exemplary view of a section named behavior of the electronic document i.e., the medical intake form that is filled by the corresponding invited user.

The one or more invited user after receiving the one or more segregated sections fills out the details therein and the filled one or more section gets compiled to automatically generate a final electronic document i.e., a medical intake form of the child in this example. In this example, the mother of the child receives and fills up the section 850 named ‘Behavior’.

The FIG. 8b shown here is just the filled-up version of the FIG. 7b. The caregiver who fills up the details in the sub-section 860 ‘Behavior’ by selecting the relevant options like ‘Cries often, poor attention, solid foods, sensitive to sounds, trouble attending to task’ and so on as the child has all such behavioral issues. Similarly, all other questions present in the section shared with user are answered by them based on their knowledge.

The section after getting fully filled up by the corresponding user shows it progress status as 100% and all the sections gets compiled automatically to generate a final electronic document.

The one more invited user after editing the document may click on the tab 870 to ‘Save’ the details entered by them. Further, the tab 880 ‘Previous’ may be used by the one or more invited user if in case more than one sections are allocated to them or the allocated section involves multiple sub-sections which are covered in multiple pages.

FIG. 9 illustrates an example implementation which discloses how a notification of the invitation to fill out the electronic document i.e., the medical intake form collaboration is communicated to one or more invited user.

The exemplary view of the one or more users invited device 900 disclosed herein is a mobile device 900 which is used by the invited user i.e., the user with whom the first user shares the share link 930 through an invitation to fill out the document in collaboration. The one or more sections of the document shared with the one or more invited user may include forms, surveys, contracts, business forms, medical forms, surveys, other structured data-entry formats and so on. In this example, we are considering the medical form of a child shared by his/her parent to the one or more invited users. The one or more invited users may include parent of the child (other than who is sharing the medical form), other family members like grandparents, siblings etc., maids, caregivers of the child, doctors of the child which may include doctor, therapist, nurses, clinician, physician etc., teachers of the child, extended family members and so on. Further, the one or more invited user device 900 may also include mobile, laptop, computer, tablet or any other similar device. The notification of the invitation 930 may also be shared with the one or more invited user via SMS, WhatsApp messaging, Telegram Messaging, Email, or any other similar platform.

The one or more invited user device 900 includes a notification heading named ‘Invitation’ 910 and the dates 920 i.e., the ‘present-day date’ on which the invitation is shared and the ‘due date’ by which the one or more section shared with the one or more invited user needs to be filled out. In the following example, an invitation message 930 includes:
“Dear ABC,
I am inviting you to fill the details in the medical form of my child in collaboration, since you have the detailed knowledge of this area.
Kindly fill in the details of the document using the link before the last date i.e., 30 Sep. 2023.
Link . . . . . . . . . . . . . . . . . . . . . . . . . . .
Thanks & Regards,
XYZ”

Here in this example, the father, XYZ of the patient i.e., the child shares the one or more section link of the medical intake form received from the hospital, where the treatment of his child is taking place to ABC asking him to fill out the one or more section, since he has expertise in the one or section allocated to him. In an exemplary scenario, if the section shared includes the details of the behavior of the child, then it could be shared with the person with whom the child spent most of the time like his caregiver or mother. Similarly, if the details of parents and family background is needed, the father can either directly fill it by himself or else share with the mother of the child. Similarly, there can be many examples and situations which requires sharing of the one or more sections to different users as they have expertise in that area.

Once the one or more invited user, ABC (in case of present example) opens the shared link and fills out the one or more section allocated to him/her, the first user i.e., XYZ can see the updated status of the corresponding one or more section allotted to the ABC in terms of percentage of document completion.

Furthermore, the one or more invited user device 900 may receive the notification directly on the communication Apps like WhatsApp, Telegram, SMS and so on. This provides an ease of access to the first user who has the entire lengthy form or document to be filled that they do not have to fill up the entire form alone. Since there are high chances that the first user does not know all the details that needs to be filled in the document. For example, in case of the medical form of a child, if the father has received the form to fill up from the hospital, he may not have the details of the gestation history of the mother like what mother ate during pregnancy, her delivery details, behavior of the child as the father does not spend most of the time with the child and so on. So, in that case he might need help from other users like mother of the child, doctor, nurses, caregivers of the child and so on in order to ensure that the data entered in the medical intake form is correct. Since, incorrect editing of data may result in serious problems at a later stage.

Also, the first user may control the level of security and maintain privacy by sharing only the one or more specific sections to the corresponding one or more invited users who has the expertise in that particular field. In a different scenario, the first user may also edit the final document that is received from the one or more invited user after getting filled up by them in real time using the user interface of the platform in which the document is accessible to the first user. In an exemplary scenario, if the one or more invited user enters some information on the allocated corresponding one or more section which the first user finds that it is somewhat wrong and needs to be changed, the first user in that case may edit the final document and save the changes to it and create a new updated version of the final document. Now both the versions of the documents get saved in the memory and may be used in future, if needed.

FIG. 10 illustrates an example implementation which discloses how a notification of the reminder to fill out the electronic document i.e., the medical intake form in collaboration is communicated to one or more invited user.

The exemplary view of the one or more users invited device 1000 disclosed herein is a mobile device 1000 which is used by the invited user i.e., the user with whom the first user shares the share link 1030 to fill out the electronic document in collaboration. The one or more sections of the document shared with the one or more invited user may include forms, surveys, contracts, business forms, medical forms, surveys, other structured data-entry formats and so on. In this example, we are considering the medical intake form of a child shared by his/her parent to one or more invited user device 1000. The one or more invited users may include parent of the child (other than who is sharing the medical form), other family members like grandparents, siblings etc., maids, caregivers of the child, doctors of the child which may include doctor, therapist, nurses, clinician, physician etc., teachers of the child, family members, extended family members of the child and so on. Further, the one or more invited user device 1000 may also include mobile, laptop, computer, tablet, or any other similar device. The notification of the invitation 1030 may also be shared with the one or more invited user via SMS, WhatsApp messaging, Telegram Messaging, Email, or any other similar platform.

The one or more invited user device 1000 includes a notification heading named ‘Reminder’ 1010 and the dates 1020 i.e., the ‘present-day date’ on which the reminder to fill out the one or more sections of the document is shared and the ‘due date’ by which the one or more section shared with the one or more invited user needs to be filled out. In the following example, an invitation message 1030 includes:
“Dear ABC,
This is a gentle reminder that you have been invited to collaborate on the document editing, since you acquire the detailed knowledge on that section.
Kindly fill in the details of the document using the link before the last date i.e., 30 Sep. 2023.
Thanks & Regards,
XYZ”

Here in this example, the father, XYZ of the patient i.e., the child shares a reminder message 1030 to the invited user ABC who has expertise in that particular field. Upon receiving the reminder message 1030 from the first user i.e., XYZ, the invited user i.e., ABC gets a reminder notification asking him to fill out the corresponding one or more sections allotted to him in the allotted time. The reminder message 1030 is usually send after say 1 week of sharing the invitation. The duration of sending the reminder message 1030 may vary depending upon the situations like urgency of document submission and so on.

Once the one or more invited user, ABC in case of present example opens the shared link and fills out the one or more section allotted to him, the first user i.e., XYZ can see the updated status of the corresponding one or more section allotted to the ABC in terms of the percentage editing of the document.

Furthermore, the one or more invited user device 1000 may receive the notification directly on the communication Apps like WhatsApp, Telegram, SMS and so on. This provides an ease of access to the first user who has the entire lengthy form or document to be filled that they do not have to fill up the entire form alone. It should be noted that the notification can also be received by the user who is sharing these sections with one or more invited users.

Further, the systems and method described above may use large language models to fill in a few details automatically in the document. For example, if a user has filled an intake form in the past and now, he is changing his medical practitioner, rather than editing a new form from scratch the model can fetch the details filled in the previous form based on a sematic search. Similarly, if there are some details that exist in the public domain such as details of the practitioner and his address, the model can automatically fetch and populate those details in the document.

As described throughout this application the term “document” is used to mean any kind of documents that encompass various forms, reports, contracts, applications, surveys, and other structured data-entry formats. Also, the terms “users” disclosed herein refers to the various types of users like first user who shares the document and the one or more invited users who receives and fills out the corresponding section of the document allocated to him/her. The types of users vary on the basis of the type of the document. For example, the if the electronic document is a medical form, then the first user may be father or mother or any caregiver of the patient, if the electronic document is a business contract, then the first user may be CEO, CFO, stakeholders of the organization or company and so on. Similarly, in the same fashion, the one or more invited users vary with respect to the type of electronic document. For example, in case of electronic document as a medical intake form, the one or more invited user may include parents, caregivers, family, extended family, doctor, teacher, coaches, therapist, nurses, maids of the patient and so on. Similarly, in case of electronic document as a business contract, the one or more invited users may include stakeholders of the company, some persons at senior levels of the company, person from other organization with whom the contract is getting signed and so on. Further the term ‘electronic document’ may include all kind of documents which are digitally available, online documents and other documents of similar kind. In addition, the system of the present disclosure is relatively inexpensive, safe, and easy to use.

Exemplary Technical Advancements: The present disclosure described herein above to fill out an electronic document in collaboration with one or more users has several technical advantages including, but not limited to, the realization of:
real-time collaboration with one or more users who have detailed knowledge with respect to the allocated one or more section;
allows sharing of only one section not the whole document, which helps in maintaining data privacy;
reduces error and duplication;
enhances efficiency and improves communication;
supports multilingual collaboration;
supports version control and tracking;
user friendly;
easy to use;
versatility of the user interface;
provides notifications to one or more users if they do not respond in time;
automatically compiles the filled-out section to generate a final document;
does not require manual intervention; and
maintains transparency and security of the data.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles, or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A method to edit an electronic document in collaboration with one or more users comprising:
segregating the electronic document into corresponding one or more sections
allocating the one or more sections of the electronic document to one or more users;
sharing each of the one or more segregated sections with the one or more users, wherein the sharing includes providing an access link to each of the one or more users to access their allocated section;
receiving one or more filled out sections from the corresponding one or more users; and
compiling the filled out one or more sections to automatically generate a final electronic document.

2. The method as claimed in claim 1, wherein the one or more users comprises a first user who shares the invite and one or more invited users who receives the invitation to fill out the one or more sections of the document.

3. The method as claimed in claim 1 displays the real time editing updates of the one or more shared sections as the one or more invited users fill out one or more shared sections at different time.

4. The method as claimed in claim 1 further comprises incorporation of one or more multimedia elements into the one or more sections by the invited users, wherein the one or more multimedia elements comprises one or more images, video files, audio files or a combination thereof.

5. The method as claimed in claim 1 further comprises creation of version history to track and monitor the changes done in each version of the electronic document.

6. The method as claimed in claim 1, wherein the one or more sections shared with the one or more users for collaborative document editing is encrypted and shared over a communication network using secured protocols in order to safeguard against unauthorized access.

7. The method as claimed in claim 1 generates an audit trail and activity log recording of all interactions, edits, communications made between the one or more invited users, thereby providing a comprehensive record of the collaborative process for review and accountability purpose.

8. The method as claimed in claim 1 further comprises sending one or more notifications to one or more users about the shared one or more sections of the electronic document, wherein the notification relates to one or more of the following—access link shared to access the section, reminder to fill the section within a given time, delay in editing the section, and importance of details that the one or more user is requested to provide in the shared section.

9. The method as claimed in claim 1, wherein the method further comprises multi-level delegation, wherein the one or more users receiving the allocated one or more sections for editing further delegates the sections to a third set of users.

10. The method as claimed in claim 1 allows sharing the one or more segregated sections to the one or more users using their contact details which may include email id or phone number of the one or more user or a combination of both.

11. A computer implemented system to edit an electronic document by collaborating with one or more users, the system comprising:
a computing device comprising a user interface configured to allow access to a collaborative document editing platform;
a memory to store instructions; and
a processing device that includes one or more processors operatively coupled to the platform and is configured to execute instructions to:
allocate one or more sections of the electronic document to one or more users, wherein a first user provides information related to one or more users to whom the one or more corresponding sections are to be allocated;
segregate the electronic document into one or more sections based on the allocation;
share each of the one or more segregated sections with the one or more user, wherein an access link is shared with each of the one or more users on their computing device to access their allocated one or more section;
receive one or more filled out sections from the corresponding one or more users; and
compile the filled out one or more sections to automatically generate a final electronic document, wherein the final electronic document includes information received from each of the one or more users.

12. The system as claimed in claim 11, wherein the collaborative document editing platform is further configured to assign different permission levels to the one or more invited users, wherein the permission levels dictate the extent of editing and access rights granted to the corresponding one or more invited user for their allocated one or more segregated section.

13. The system as claimed in claim 11, wherein the collaborative document editing platform is further configured to maintain a version history for each of the shared one or more sections, wherein the collaborative document editing platform tracks changes made by the one or more user in their shared sections in real-time.

14. The system as claimed in claim 11, wherein the collaborative document editing platform is integrated with one or more of cloud storage services, automatic backup services, synchronization services, and secure storage services.

15. The system as claimed in claim 11, wherein the collaborative document editing platform provides multilingual support, allowing one or more users to fill their allocated one or more sections in their preferred language.

16. The system as claimed in claim 11, wherein platform maintains a log of user activities, including logins, document access, edits, and comments, providing an audit trail for security and compliance purposes.

17. The system as claimed in claim 11, wherein collaborative document editing platform comprises multi-level delegation, wherein the one or more users receiving the allocated one or more sections for editing further delegates the sections to a third set of users.

18. The system as claimed in claim 11 further comprises natural language processing techniques to perform semantic searching on available documents, wherein the system fetches answers to similar meaning questions asked in different ways based on the semantic searching.

19. The system as claimed in claim 11 further comprises an AI platform that includes a Large Language Model (LLM) to automatically generate responses to questions asked in a document based on access to a central or distributed database.

20. The system as claimed in claim 11, wherein the system is configured to share one or more sections of the document to one or more users for periodic updates, wherein the sections are shared with one or more invited users either automatically or based on manual triggers such that the updates filled by the users in one or more sections are received to generate an updated document having up-to-date information.
